(19) United States
(12) Patent Application Publication
(10) Pub. No.: US 2008/0092453 A1
(43) Pub. Date: Apr. 24, 2008

(54) Motor Vehicle Door

(75) Inventor: Michael Fuetterer, Hildrizhausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/632,414

(22) PCT Filed: Jun. 18, 2005
(86) PCT No.: PCT/EP05/06609

§ 371 Date: Aug. 8, 2007

(30) Foreign Application Priority Data
Jul. 15, 2004 (DE) 20 2004 015 344.0
Nov. 18, 2004 (DE) 10 2004 055 567.2
Mar. 1, 2005 (DE) 10 2005 009 183.0

(51) Int. Cl. B60J 5/04

(52) U.S. Cl. 49/502

(57) ABSTRACT

A motor vehicle door includes an outer module and an inner module. The inner module has a supporting structure that includes a metallic frame which is joined to a plastic base support to form a metal-plastic hybrid component. A fastening web which serves to receive a door seal is molded onto the plastic base support of the hybrid component.

### CROSS REFERENCE TO RELATED APPLICATIONS

This application is a national stage of PCT International Application No. PCT/EP2005/006609, filed Jun. 18, 2005, which claims priority under 35 U.S.C. § 119 to German Patent Application Nos. 20 2004 015 344.0 filed Jul. 15, 2004, 10 2004 055 567.2 filed Nov. 18, 2004, and 10 2005 009 183.0 filed Mar. 1, 2005, the entire disclosures of which are herein expressly incorporated by reference.

### BACKGROUND AND SUMMARY OF THE INVENTION

The present invention relates to a motor vehicle door.

Door seals on motor vehicle doors are generally fitted to the doors by an adhesive connection. Furthermore, it is customary to pull the door seal onto a suitable strip, usually a plastic strip, which is in turn fastened to the motor vehicle door by a plug-in or a clip connection or is inserted into a retaining rail.

The adhesive connection is not reversibly releasable in the event of a repair, which entails increased costs for repair work. In the case of the plug-in connection, as described, for example, in German patent document DE 198 05 610 C2, an additional component is required, as a result of which the production costs are increased.

An object of the invention is to provide a door seal for a motor vehicle door, which is reversibly releasable and can be produced cost-effectively.

This and other objects and advantages are achieved by the motor vehicle door according to the present invention, which includes an outer and an inner module, with a fastening web, which serves to receive a door seal and is integrally formed on the inner module.

The integral formation of the fastening web on the inner module of the motor vehicle door can run continuously along the sealing region. The door seal is usually clamped on the fastening web. The fastening web can be integrally formed in a cost-effective manner during production of the inner door module. In particular, when an inner door module of plastic is used, the integral forming process of the fastening web can be integrated into an injection molding shaping process of the inner module. No further production step is therefore required in order to integrally form the fastening web. In principle, the fastening web can also be configured in the form of a fold which is integrally formed during the deformation of a metal sheet. This is expedient if the inner module is formed from a sheet-metal part in the region of the door seal.

In one refinement, the inner module has a supporting structure which includes a reinforcing frame. This reinforcing frame is joined to a plastic base support so as to form a hybrid component. In this case, the hybrid component is configured in such a manner that it improves the rigidity of the inner module and therefore of the entire door and, at the same time, can form the supporting surface of the inside door lining.

The reinforcing frame is frequently configured in the form of a metallic frame, with use being made of metals, such as steel, aluminum or magnesium, which can be produced by a conventional forming technique and by casting techniques. However, it is also expedient to produce the reinforcing frame from an insert in the form of a fiber-reinforced plastic.

The supporting structure of the inner module is therefore configured by an integrated hybrid component. The absence of a supporting hybrid component in the center of the door therefore significantly improves the utilization of the construction space in the vehicle door, increases the rigidity and facilitates the installation of add-on parts, since add-on parts can be greatly integrated onto the hybrid component per se.

The hybrid component enables the inner module to be used at the same time as a supporting structure of the motor vehicle door, and, on the other hand, further integrated functions can be realized by the plastic base support. The integrally formed fastening web can be integrated in a particularly favorable manner into the plastic base support during production of the hybrid component. Since, during production of the hybrid component, the fastening web is arranged in an unmolding direction of the hybrid component in a die, no undercuts occur either. For this reason, additional slides in the injection molding die are not needed.

In a further embodiment of the invention, the door seal has a fastening region and a sealing region in its cross section. In this case, the fastening region may be reinforced by a metallic core. The insertion of a metallic core makes it possible to increase the clamping force of the fastening region on the fastening web, which results in the seal being better seated on the fastening web.

The supporting structure of the inner module can be configured in such a manner that it additionally includes a window ledge and/or a door base and also a rear door end side. The integration of these narrow sides of the motor vehicle door into the inner module makes it possible for the outer module to be of correspondingly narrower design, which in turn leads to the separating plane between inner and outer modules being able to be shifted further in the direction of the outside of the vehicle, which in turn leads to an increase in the elbow room in the passenger compartment.

In this case, the rear door end side on the inner module can be configured in such a manner that a door lock is arranged on it. The arrangement of the door lock on the separately preassemblable, inner module improves the overall outlay during the installation of the motor vehicle door.

In an embodiment of the invention, a door seal runs along a joining surface in which the outer and the inner modules are joined together. This serves to better seal the joining surface can also serve to cover screw points, which run along the joining surface, by the door seal at the same time, which affords visual advantages. The use of the fastening web makes it possible for the door seal to be mounted via the screw point in a simple manner and to be easily removed and reattached in the event of a repair.

The supporting structure of the inner module, which is configured in the form of the above-mentioned hybrid component, can be geometrically shaped in such a manner that installation spaces for corresponding add-on parts, such as add-on units, are formed in the desired manner on the inner module.

In this case, in an advantageous manner, the plastic base support, which forms part of the hybrid component, can have fasteners which are already integrated into the plastic base support by the production process. These fasteners may serve to fasten add-on parts in units.

Other objects, advantages and novel features of the present invention will become apparent from the following detailed description of the invention when considered in conjunction with the accompanying drawings.

### BRIEF DESCRIPTION OF THE DRAWINGS

FIG. 1 is a view of the outer motor vehicle door module, as seen from the inside to the outside,

FIG. 2 is a view of the inner module with a view from the outside to the inside,

FIG. 3 shows the supporting structure of the hybrid component of the inner module with a graphical differentiation between reinforcing frame and plastic base support,

FIG. 4 is a schematic illustration of a vehicle door, in which the position of the sections according to FIGS. 5 to 7 is shown,

FIG. 5 shows a section along the line V from FIG. 4,

FIG. 6 shows a section along the line VI from FIG. 4.

### DETAILED DESCRIPTION OF THE DRAWINGS

In the text below, the use of the advantageous fastening web is combined with a motor vehicle door of modular construction. The construction of the motor vehicle door is discussed initially to aid comprehension.

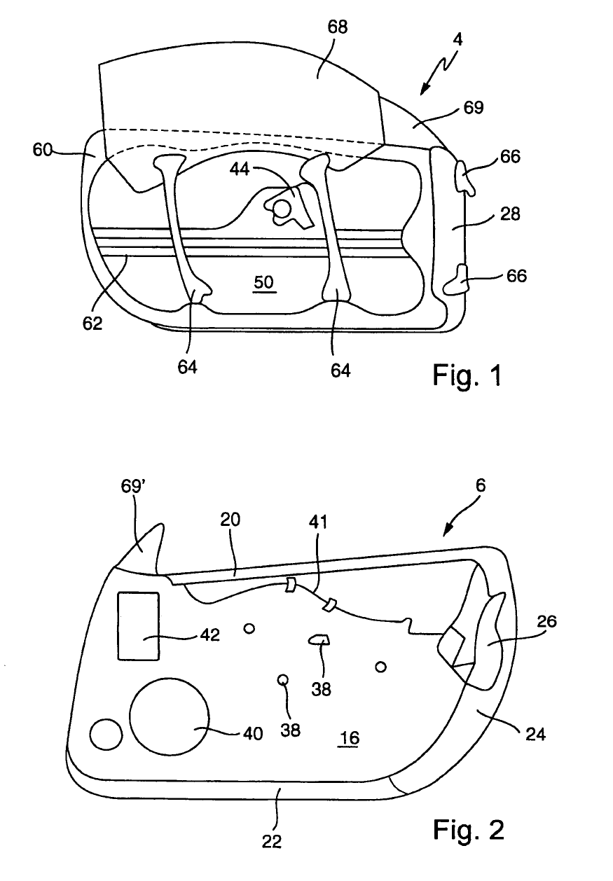

An illustration of an outer module 4 of a motor vehicle door 2 (cf. FIG. 4) is provided in FIG. 1. The outer module 4 in this case includes a frame 60 to which an outside panel 50 is attached, and a side impact protection unit 62 which runs from a front to a rear end of the module and ends in a front end side 28 of the door, and which also conceals hinges 66. The construction of the front door end side 28 is explained in more detail in the description of FIG. 7.

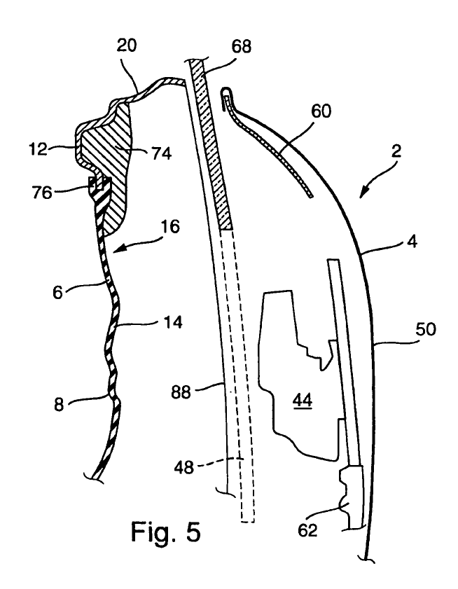

Furthermore, the outer module includes a window 68 and rails 64 of a window lifter and a drive unit 44 of a window lifter, which is mounted on a bulging portion of the side impact protection unit 62. As can be seen in FIG. 5, the drive unit 44 of the window lifter lies outside a window plane 48 (FIG. 5), which is advantageous for the construction space in an inner module 6.

In principle, the outer module can also include regions of the door base, the window ledge and the front and rear door end sides. However, there are efforts to largely integrate these narrow sides of the door in an inner module 6.

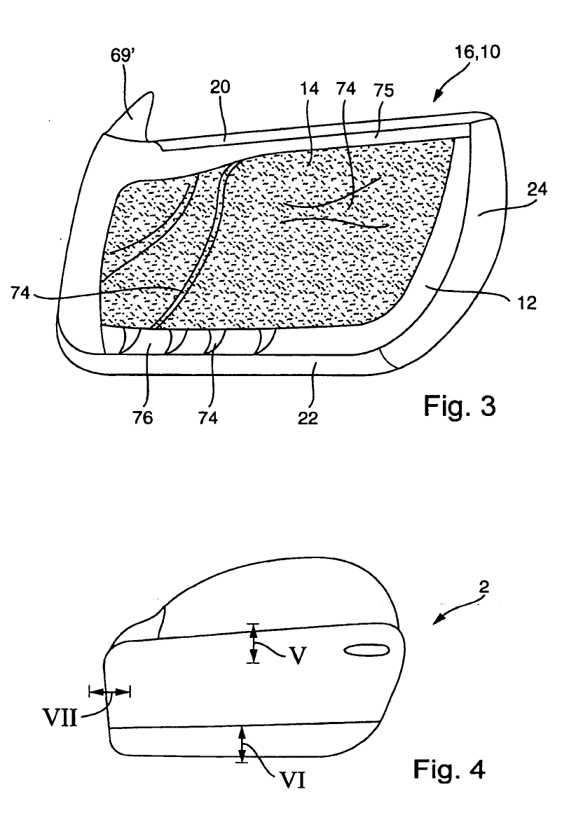

The inner module 6 of the motor vehicle door 2 is illustrated in FIG. 2. The view of the inner module 6 in this illustration runs from the outside to the inside. The inner module 6 is based essentially on a supporting structure 10 which in turn is formed by a hybrid component 16, which is viewed separately and in detail in FIG. 3.

In addition to the hybrid component 16, the inner module 6 includes various add-on parts 40, for example, speakers or installation units 42, such as a door control device. Furthermore, fasteners 38, to which further add-on parts, for example, door handles, can be fastened, are integrated in a plastic base support 14 (cf. FIG. 3). Furthermore, the inner module 6 includes supply lines 41, such as electric cables or Bowden cables, for actuating locks. A door lock 26 is likewise integrated in the inner module in the region of a rear end side 24 of the door.

Furthermore, in this embodiment, the inner module includes a window ledge 20 which protrudes outward from the passenger compartment in the direction of the window 68, and a door base 22 which delimits the lower side of the door. The integration of these narrow sides, namely the window ledge 20, the door base 22 and the rear door end side 24, leads to the inner module 6 being of significantly thicker configuration in comparison to the outer module 4. This, in turn, affords the possibility of providing installation spaces for the add-on parts 40 and units 42 already discussed in the inner module. Furthermore, in this embodiment, the outer module 4 and the inner module 6 include respective triangular mirrors 69 and 69′.

FIG. 3 illustrates the supporting structure 10, which is formed by the hybrid component 16, in more detail. The hybrid component 16 essentially includes a reinforcing frame 12, which is illustrated in white in FIG. 3 and is configured in the form of a metallic frame 12. The latter is referred to below as the metallic frame. Furthermore, the hybrid component includes a plastic base support 14, which is realized in dotted form in the illustration according to FIG. 3. In this embodiment, the frame 12 includes a plurality of inserted sheet-metal structures which in this case include the window ledge 20, the rear end side 24 and the door base 22. Next to these narrow sides, the metallic frame 12 is drawn into a side surface of the hybrid component 16, which further stiffens the hybrid component 16. The center of the side surface 75 is formed by the plastic base support 14.

In order to produce the hybrid component 16, frame elements which form the reinforcing frame, in particular the metallic frame 12, are placed into a suitable injection mold, with free regions, which later form the plastic base body 14, being injected with a plastic compound. In this case, the frame elements are encapsulated by the plastic compound by injection molding and/or are injected through in regions of cutouts in the frame elements by the plastic compound, thus resulting in a fixed and stiff connection of the frame elements. If required, before being placed into the mold, the frame elements may also be joined to one another by welding or by a different joining method.

In this case, it is expedient to integrate plastic ribs 74 into the plastic base support 14 in order to additionally stiffen the hybrid component 16. During this injection molding process, the fasteners 38 which have already been described (cf. FIG. 2) can also be integrated at the same time. As a rule, regions 76 of the frame are also covered by the plastic base support, which is necessary in order to improve the connection between plastic base support 14 and metallic frame 12 and can serve as a coating for the frame. This measure also enables fasteners 38 in the region of the frame 12 or above the metallic frame 12 to be configured from plastic. In addition to sheet-metal parts, the metallic frame 12 may also include cast parts, such as aluminum, magnesium or else thin-walled cast steel. Furthermore, the use of fiber-reinforced plastics as frame elements is expedient. Frame elements of this type may be reinforced, for example, by glass fibers, aramide fibers or carbon fibers in the form of long fibers.

The metallic frame 12 is illustrated merely by way of example in its embodiment in FIG. 3. A plurality of different embodiments of the metallic frame is conceivable here. For example, sheet metal can run diagonally through the hybrid component 16. It is also not a prerequisite in all cases for the metallic frame 12 to surround the hybrid component 16 from the outside and along the narrow sides. However, the configuration of the narrow sides of the metallic frame provides an expedient and advantageous stiffening of the hybrid component 16.

On a passenger compartment side (not visible in FIG. 3), the entire hybrid component 16 has a supporting surface 8 (cf. FIG. 5) which can be provided for decorative reasons in the interior with a coating, for example, by leather, materials or plastic linings. This supporting surface 8 of the hybrid component 16 is generally essentially formed by the plastic base support 14. This means in general that, on a passenger compartment side of the hybrid component 16, the frame 12 is amply covered by the plastic base support 14.

In FIG. 5, which illustrates a section along the line 5 from FIG. 4 in the region of the window ledge, the outer module 4 is depicted on the right side and the inner module 6 is depicted on the left side. A window 68 and a window plane 48 (illustrated by dashed lines) run between the two modules. It can be seen here that, contrary to a conventional construction of motor vehicle doors, an inside door panel, which is generally arranged between the window plane 48 and a support part for inside add-on parts, is omitted. In this construction, the reinforcing action of the customary inside door panel is formed by the hybrid component with its metallic frame 12 and the plastic base support 14.

The absence of this inside door panel means that the window plane is open on the outer module 4, as also illustrated in FIG. 1, The installation and setting of the window and of the window lifter components is thereby significantly facilitated.

Due to the substantial integration of the window ledge 20, the door base 22 (not shown in FIG. 5), and the rear door end side 24 into the inner module 6 (which features are fitted to the outer module in the customary construction) and due to the simultaneous saving of the inside door panel, the inner module 6 can be brought significantly closer to the window plane 48 and can be of correspondingly thinner configuration, which is of direct advantage for the elbow room in the passenger compartment. The absence of a hybrid component in the center of the motor vehicle door in front of the window plane also leads to the inner module 6 being able to be of correspondingly thinner configuration and to the elbow room being able to be increased.

In addition to the frame 60 of the outer module and the outside panel 50, the outer module 4 in FIG. 5 has a side impact protection unit 62 to which the drive unit 44 for the window lifter is fastened. In particular, in the case of vehicles with convex doors, this construction space can be used for accommodating the drive unit 44.

In the section through the inner module 6 in FIG. 5, in addition to the metallic frame 12, which includes the window ledge 20, the plastic base support 14 is also illustrated. The plastic base support 14 overlaps the metallic frame 12 in an overlapping region 76. In this illustration, the overlapping region 76 is configured to be very short; it may, as already indicated, also include the entire region of the metallic frame 12 on the interior side and therefore form the supporting surface 8 for the inside door lining. Furthermore, this sectional illustration schematically depicts a ribbed structure 74 which is integrated into the plastic base support 14 but runs beyond the latter into the frame 12 and therefore reinforces the frame 12 here in the region of the window ledge 20.

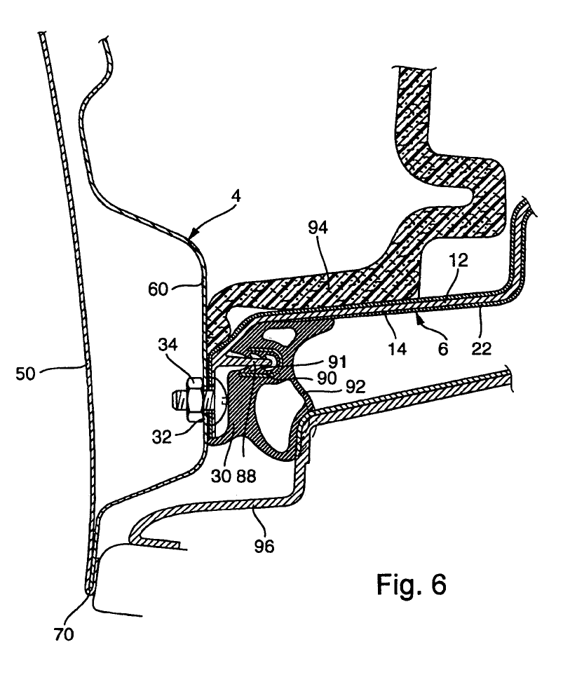

The section illustrated in FIG. 6 through the vehicle door 2 along the line 6 from FIG. 4 shows the cross section of the motor vehicle door 2 in the region of the door base. On the left side, the illustration shows the outer module 4, which includes the outside panel 50 and the frame of the outer module 60, the outside panel 50 being connected to the frame 60 in a fold 70 at the lower edge of the figure. Furthermore, the inner module 6 in the region of the door base 22 is depicted on the right side of FIG. 6. In this region, the door base 22 is mainly formed by the metallic frame 12 of the hybrid component 16, the frame being overlapped by the plastic base support 14.

The inner module 6 is screwed to the outer module 4 at an overlapping joining surface 32 by a plurality of screw points 34. The joining surface 32 with the screw points 34 is concealed by a door seal 30. This has visual advantages, namely that the joining surface 32 cannot be seen, and contributes to the sealing of the joining surface 32.

Somewhat above the screw point 34, an integrated fastening web 88 is integrally formed on the plastic base support 14. The door seal 30 is placed on the fastening web 88. The door seal 30 has a fastening region 90 and a sealing region 92 in its cross section. In this case, the fastening region 90 is of approximately U-shaped configuration, wherein tooth-like formations are provided in the interior of the U-shape, which formations, when the fastening region 90 is pushed over the fastening web 88, press against the fastening web 88 and therefore prevent the door seal 30 from slipping down from the fastening web 88. For further support, a metallic core (not shown) is embedded in the fastening region 90 along the U-shape. The metallic core can be configured, for example, in the form of a metal sheet bent in a U-shaped manner and can be cast into the door seal at the same time. The metallic core acts approximately in the manner of a spring and presses the door seal in the fastening region 90 onto the fastening web 88.

The sealing region 92 of the door seal 30 covers the screw point 34 and the entire joining surface 32 between the outer module 4 and the inner module 6. Furthermore, the sealing region 92 of the door seal 30, which sealing region surrounds a hollow cross section 93, is configured in such a manner that it bears against a side wall cutout (specifically a sill 96 of the motor vehicle), and the door seal 30 is pressed in the region of the hollow cross section 93. This ensures tight sealing between sill 96 and motor vehicle door 2.

The example illustrated here shows the door seal 30 in the region of a door base or in the region of a sill 96. The door seal 30 can be configured analogously in this shape along the profile of the sealing surface 32 on the motor vehicle door 2.

The fastening web 88 can be integrated in a simple manner on the plastic base support 14 during the production process. All that is necessary for this is for the injection molding die for producing the hybrid component 16 to contain a corresponding formation for the fastening web 88. The fastening web 88 may point in a demolding direction of the injection molding die, thus making it possible to dispense with the use of complicated and costly slides.

The door seal 30, which is pushed on the fastening web mounted 88, is mounted there in a manner secure against slipping through the assistance of the fastening teeth 91 and through being pressed on by the metallic core. However, if the need arises, it can be pulled off without considerable effort, thus making the screw point 34 freely accessible. The inner module 6 can therefore easily be unscrewed from the outer module in order, for example, to get to units in the interior of the motor vehicle door 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A motor vehicle door, comprising:
an inner module;
an outer module; and
a fastening web integrally formed on the inner module and configured to receive a door seal.

15. The motor vehicle door as claimed in claim 14, wherein the inner module has a supporting structure which comprises a reinforcing frame joined to a plastic base support to form a hybrid component.

16. The motor vehicle door as claimed in claim 15, wherein the fastening web is integrally formed on the plastic base support.

17. The motor vehicle door as claimed in claim 14, wherein:
the door seal has a fastening region and a sealing region in its cross section; and
the fastening region is reinforced by a metallic core.

18. The motor vehicle door as claimed in claim 15, wherein the supporting structure comprises a window ledge or a door base.

19. The motor vehicle as claimed in claim 15, wherein the supporting structure comprises a rear end side of the door.

20. The motor vehicle door as claimed in claim 14, wherein a door lock is arranged on a rear end side of the inner module.

21. The motor vehicle door as claimed in claim 14, wherein the door seal runs along a joining surface of the outer module and the inner module.

22. The motor vehicle as claimed in claim 14, wherein the door seal conceals a screw point of the joining surface of the outer module and the inner module.

23. The motor vehicle door as claimed in claim 15, wherein the supporting structure of the inner module comprises installation spaces for add-on parts and units.

24. The motor vehicle door as claimed in claim 15, wherein the plastic base support of the hybrid component includes fasteners for add-on parts and units.

25. The motor vehicle door as claimed in claim 15, wherein the reinforcing frame is formed by a metal reinforcement.

26. The motor vehicle door as claimed in claim 15, wherein the reinforcing frame is formed by an insert of fiber-reinforced plastic.

27. The motor vehicle door as claimed in claim 15, wherein the door seal has a fastening region and a sealing region in its cross section, wherein the fastening region is reinforced by a metallic core.

28. The motor vehicle door as claimed in claim 16, wherein the door seal has a fastening region and a sealing region in its cross section, wherein the fastening region is reinforced by a metallic core.

29. The motor vehicle door as claimed in claim 16, wherein the supporting structure comprises a window ledge or a door base.

30. The motor vehicle as claimed in claim 16, wherein the supporting structure comprises a rear door end side.

31. The motor vehicle door as claimed in claim 15, wherein a door lock is arranged on the rear door end side of the inner module.

32. The motor vehicle door as claimed in claim 15, wherein the door seal runs along a joining surface of the outer module and the inner module.

33. The motor vehicle as claimed in claim 15, wherein the door seal conceals a screw point of the joining surface of the outer module and the inner module.
